(19) United States
(12) Patent Application Publication
(10) Pub. No.: US 2014/0373185 A1
(43) Pub. Date: Dec. 18, 2014

(54) Anti-theft Method and Computer System thereof

(71) Applicant: Wistron Corporation, New Taipei City (TW)

(72) Inventor: Yung-Yen Chang, New Taipei City (TW)

(73) Assignee: Wistron Corporation, New Taipei City (TW)

(21) Appl. No.: 14/185,894

(22) Filed: Feb. 20, 2014

(30) Foreign Application Priority Data
Jun. 18, 2013 (TW) 102121623

(51) Int. Cl. G06F 21/88

(52) U.S. Cl. CPC G06F 21/88
USPC 726/35

(57) ABSTRACT

An anti-theft method for a computer system including a detection module, a photographing module and a controlling module is disclosed. The anti-theft method includes when the computer system is off, the detection module determines whether a predetermined event occurs for generating a detection signal; the controlling module initiates the computer system according to the detection signal, such that the computer system operates a basic input/output system (BIOS); and when the computer system operates the BIOS, an anti-theft operation is initiated to control the photographing module for capturing a digital information.

### BACKGROUND OF THE INVENTION

1. Field of the Invention

The present invention relates to an anti-theft method and a computer system thereof, and more particularly, to an anti-theft method and a computer system thereof which utilize a bios input-output system (BIOS) setting menu to adaptively control a photographing module and a remote server.

2. Description of the Prior Art

As technology advances, people use digital files as well as pictures to process routine work and record daily lives, such that digital products and computer systems equipped with various functions have become necessary in people's daily lives. For the convenient utilization, many digital products and computer systems have inherited portable characteristics, but the corresponding convenience gives chances to wicked/immoral people to easily steal the devices. Conventionally, users may utilize a hardware key or a software protection to prevent theft. However, the hardware key may be inconvenient to carry, and the software protection has potential risks to be cracked, such that both have limitations for protection. Thus, it is important to provide another efficient anti-theft method and computer system thereof for better protection.

### SUMMARY OF THE INVENTION

It is therefore an objective of the invention to provide an anti-theft method and a computer system thereof which utilize a bios input-output system (BIOS) setting menu to adaptively control a photographing module and a remote server.

An embodiment of the invention discloses an anti-theft method for a computer system comprising a detection module, a photographing module and a controlling module. The anti-theft method comprises when the computer system is off, the detection module determines whether a predetermined event occurs for generating a detection signal; the controlling module initiates the computer system according to the detection signal, such that the computer system operates a basic input/output system (BIOS); and when the computer system operates the BIOS, an anti-theft operation is initiated to control the photographing module for capturing a digital information.

An embodiment of the invention also discloses another computer system for processing an anti-theft method. The computer system comprises a central processing unit coupled to a detection module, a photographing module and a controlling module; and a basic input/output system (BIOS) read-only memory (ROM) coupled to the central processing unit for storing a programming code, and the programming code is utilized to instruct the central processing unit for processing the anti-theft method. The anti-theft method comprises when the computer system is off, the detection module determines whether a predetermined event occurs for generating a detection signal; the controlling module initiates the computer system according to the detection signal, such that the computer system operates a basic input/output system (BIOS); and when the computer system operates the BIOS, an anti-theft operation is initiated to control the photographing module for capturing a digital information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a computer system according to an embodiment of the invention.

FIG. 2 illustrates a schematic diagram of a detection module according to an embodiment of the invention.

FIG. 3 illustrates a flow chart of an anti-theft process according to an embodiment of the invention.

FIG. 4 illustrates a flow chart of a determination process according to an embodiment of the invention.

FIG. 5 illustrates a schematic diagram of a BIOS setting menu according to an embodiment of the invention.

FIG. 6 illustrates a schematic diagram of a security setting menu according to an embodiment of the invention.

### DETAILED DESCRIPTION

The specification and the claims of the present invention may use a particular word to indicate an element, which may have diversified names named by distinct manufacturers. The present invention distinguishes the element depending on its function rather than its name. The phrase “comprising” used in the specification and the claim is to mean “is inclusive or open-ended but not exclude additional, un-recited elements or method steps.” In addition, the phrase “electrically connected to” or “coupled” is to mean any electrical connection in a direct manner or an indirect manner. Therefore, the description of “a first device electrically connected or coupled to a second device” is to mean that the first device is connected to the second device directly or by means of connecting through other devices or methods in an indirect manner.

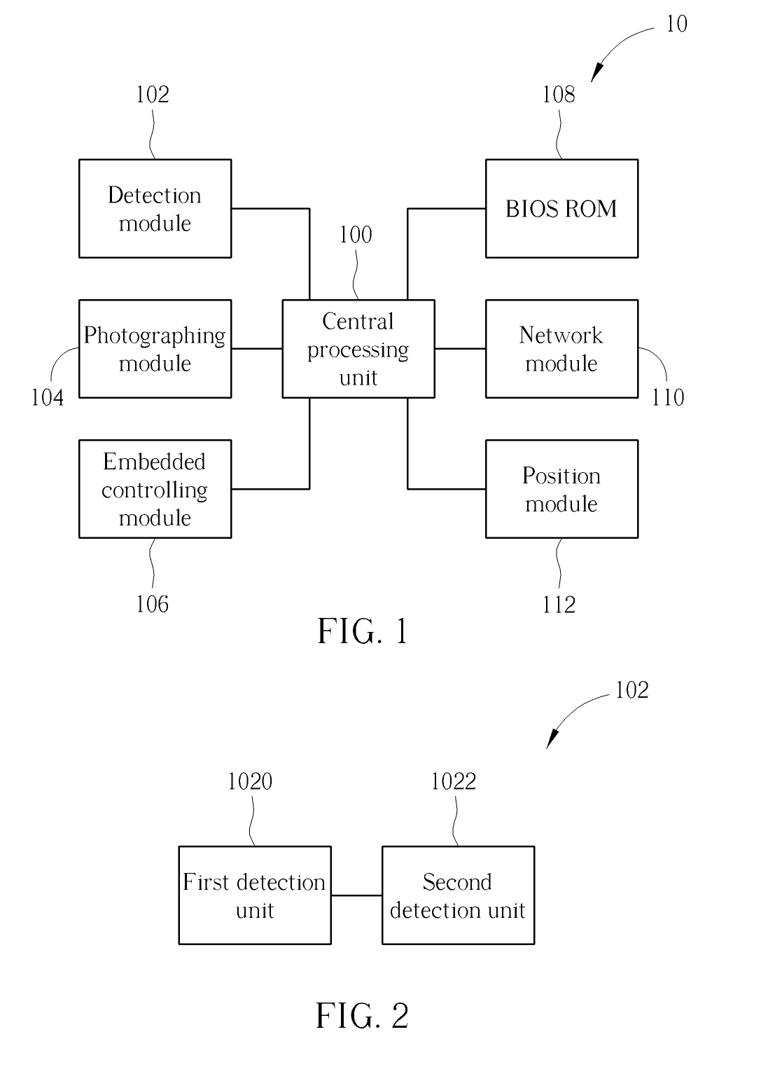

Please refer to FIG. 1, which illustrates a schematic diagram of a computer system 10 according to an embodiment of the invention. The computer system 10 has a basic structure comprising a main board, a processing unit, a memory, a hard disk, a south-bridge module, a north-bridge module, and etc, and should be well known to those skilled in the art. For the brevity, FIG. 1 only illustrates a central processing unit 100, a detection module 102, a photographing module 104, an embedded controlling module 106, a basic input/output system (BIOS) read-only memory (ROM) 108, a network module 110 and a position module 112 coupled to the central processing unit 100. Preferably, the embodiment of the invention further stores a programming code corresponding to an anti-theft method in the embedded controlling module 106 or the BIOS ROM 108, such that the central processing unit 100 can process the programming code for applying the anti-theft method to the computer system 10.

In detail, the detection module 102 is utilized to determine whether a predetermined event occurs, and the predetermined event can be realized as whether a user enters into a predetermined space of the computer system 10 or whether the user touches/moves any part of the computer system 10. The photographing module 104 can be realized as a two-dimensional/three-dimensional optical module for processing a photographing/recording operation, so as to generate a digital information. Accordingly, the digital information can be realized as a two-dimensional/three-dimensional picture information or a two-dimensional/three-dimensional video information via the two-dimensional/three-dimensional optical module. The photographing module 104 can cooperate with a face-tracking/recognition technique to recognize personal facial image information while adaptively considering different distances/angles away from the computer system 10.

Besides, the embedded controlling module 106 can be coupled to a backup power source (not shown in the figure), such that when the computer system 10 is in a turned off mode, the backup power source will be available for the computer system 10 to process the anti-theft method. The network module 110 can be utilized to provide a wireless/wired signal transmission operation between the computer system 10 and a remote server (not shown in the figure), and accordingly, the computer system 10 can transmit the digital information to remote server. The position module 112 can utilize an Access Point (AP) Wireless Tag technique, a Global Positioning System (GPS) technique or a Computrace Positioning technique to position or locate a location coordinate of the computer system 10. When the computer system 10 is connected with the remote server, the positioning module 112 can also transmit the location coordinate information of the computer system 10 to the remote server. Preferably, the remote server in the embodiment of the invention can be realized as a Trivial File Transfer Protocol (TFTP) server, such that the central processing unit 100 and the network module 110 can compile the digital information and the location coordinate information to comply with standards of TFTP, so as to interchange information with the remote server, which is not limiting the scope of the invention.

Please refer to FIG. 2, which illustrates a schematic diagram of a detection module 102 according to an embodiment of the invention. As shown in FIG. 2, the detection module 102 further comprises a first detection unit 1020 and a second detection unit 1022. In the embodiment, the first detection unit 1020 can be realized as a proximity sensor, and the second detection unit 1022 can be realized as a light sensor, an accelerometer or a gyroscope. Under such circumstances, the computer system 10 in the embodiment of the invention will sequentially operate the first detection unit 1020 and the second detection unit 1022 of the detection module 102 to determine whether a first event and a second event are respectively satisfied, so as to initiate the photographing module 104 for photographing and recording.

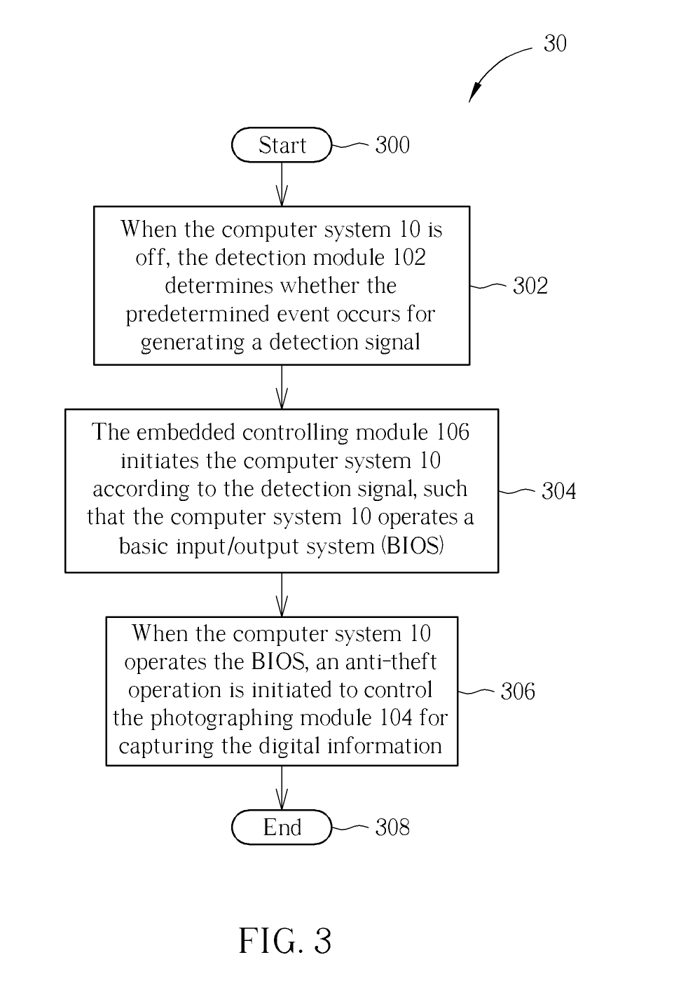

The anti-theft method for the computer system 10 in the embodiment of the invention can be summarized as an anti-theft process 30 to be compiled as the programming code stored in the embedded controlling module 106 and/or the BIOS ROM 108, as shown in FIG. 3. The anti-theft process 30 includes the following steps.

Step 300: Start.

Step 302: When the computer system 10 is off, the detection module 102 determines whether the predetermined event occurs for generating a detection signal.

Step 304: The embedded controlling module 106 initiates the computer system 10 according to the detection signal, such that the computer system 10 operates a basic input/output system (BIOS).

Step 306: When the computer system 10 operates the BIOS, an anti-theft operation is initiated to control the photographing module 104 for capturing the digital information.

Step 308: End.

In step 302, when the computer system 10 is off (or being turned off), the position module 112 will correspondingly determine an initial location coordinate and/or an initial magnetic information of the computer system 10. Further, the position module 112 will cooperate with the detection module 102 to correspondingly store an initial value corresponding to the computer system 10 in the BIOS ROM 108, so as to determine whether the predetermined event is satisfied.

In step 304, the embedded controlling module 106 initiates the computer system 10 according to the detection signal, such that the computer system 10 will operate the BIOS to enter into step 306. In step 306, after the BIOS is initiated and the anti-theft operation is processed, the computer system 10 can utilize a coil induction way or a Wireless Fidelity (Wi-Fi) induction way to correspondingly initiate the photographing module 104 for capturing the digital information.

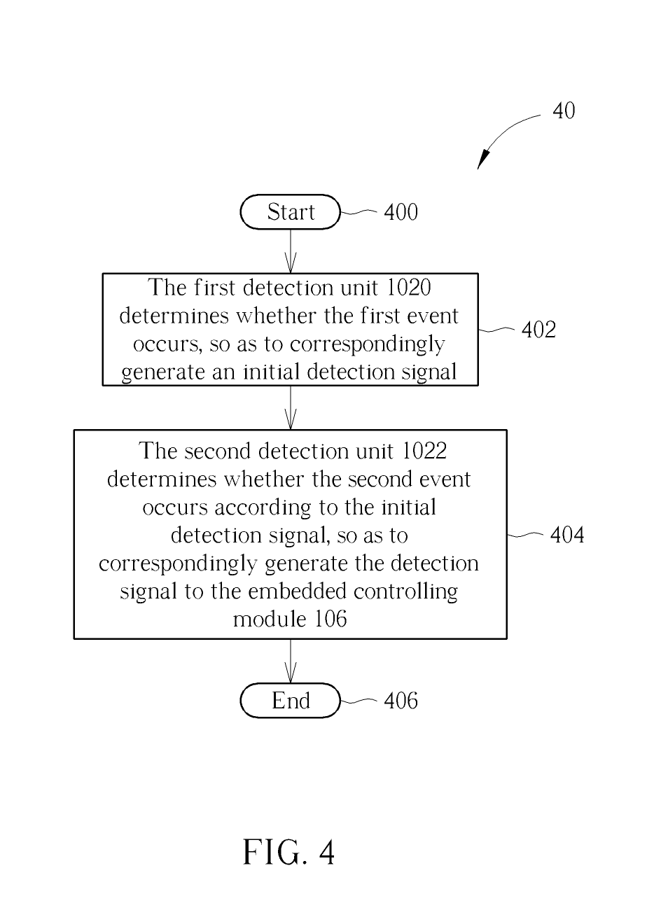

Further, in another embodiment of the invention, step 302 determines whether the predetermined event occurs via the detection module 102 to correspondingly generate the detection signal and can be summarized as a determination process 40 to be compiled as the programming code stored in the embedded controlling module 106 and/or the BIOS ROM 108, as shown in FIG. 4. The determination process 40 includes the following steps.

Step 400: Start.

Step 402: The first detection unit 1020 determines whether the first event occurs, so as to correspondingly generate an initial detection signal.

Step 404: The second detection unit 1022 determines whether the second event occurs according to the initial detection signal, so as to correspondingly generate the detection signal to the embedded controlling module 106.

Step 406: End.

In step 402, the first detection unit 1020 determines whether the user enters into the predetermined space corresponding to the computer system 10, which means that the first event in the embodiment of the invention is realized to determine whether one user is in proximity of the computer system 10. For example, a distance between the computer system 10 and the user is smaller than 10 cm. Under such circumstances, the first detection unit 1020 will generate the initial detection signal to the second detection unit 1022, so as to initiate operations of the second detection unit 1022.

In step 404, the second detection unit 1022 determines whether the second event occurs to generate a detection signal to the embedded controlling module 106, so as to correspondingly control the anti-theft operation. If the second detection unit 1022 is realized as the light sensor, the second event can be predetermined as whether a luminance information of the computer system 10 changes/alters. For example, the second detection unit 1022 is disposed onto the bottom of the computer system 10 and the computer system 10 is disposed on a table, such that a light entrance of the second detection unit 1022 will directly face the table. During the computer system 10 being moved away from the table, the second detection unit 1022 will sequentially obtain a low level of the luminance information and a high level of the luminance information, so as to determine that the second event has satisfied, wherein the low level of the luminance information is obtained as no light enters into the light sensor because of being blocked by the table, and the high level of the luminance information is obtained as a great volume of light enter into the light sensor when the table no longer blocks light from entering the light sensor.

Further, if the second detection unit 1022 is realized as the accelerator, the second event can be predetermined as whether a moving information of the computer system 10 changes/alters, wherein the moving information further comprises a velocity information and a displacement information. For example, when the computer system 10 remains still at the initial location coordinate and then is moved to a final location coordinate, the second detection unit 1022 can correspondingly record the initial location coordinate and the final location coordinate to determine whether a velocity information changes or a displacement information change has occurred, so as to determine the second event has satisfied.

Additionally, if the second detection unit 1022 is realized as the gyroscope, and the second event can be predetermined as whether a magnetic information of the computer system 10 changes/alters. For example, when the computer system 10 remains still at the initial location coordinate and has the initial magnetic information and then is moved to have a final magnetic information, the second detection unit 1022 can correspondingly record a magnetic information change between the initial magnetic information and the final magnetic information, so as to determine whether the second event has satisfied or not.

In comparison with the predetermined event in anti-theft process 30, the determination process 40 further comprises the first event and the second event. Accordingly, the determination process 40 will utilize the first detection unit 1020, the second detection unit 1022 and the initial condition (value) stored in the BIOS ROM 108 to determine whether the first event and the second event are sequentially satisfied while the computer system 10 is purposely moved/stolen, so as to generate the detection signal for initiating the anti-theft process for the computer system 10.

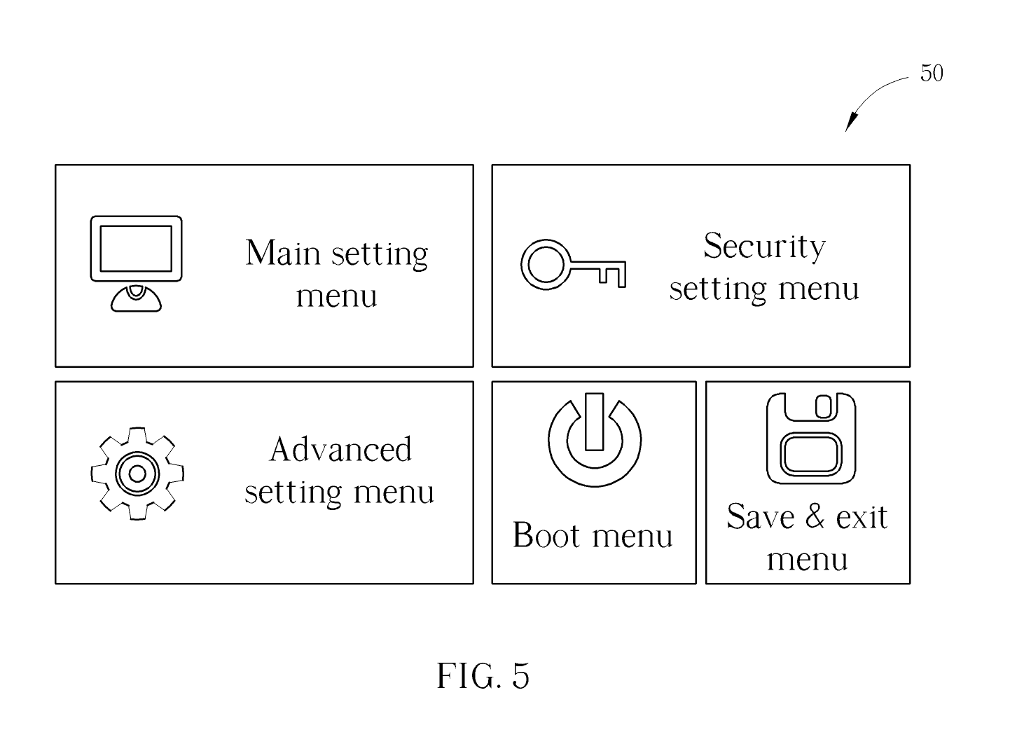

Moreover, in another embodiment of the invention, operations of step 306 can be modified to process a BIOS setting menu of the BIOS. Please refer to FIG. 5, which illustrates a schematic diagram of a BIOS setting menu 50 according to an embodiment of the invention. As shown in FIG. 5, the BIOS setting menu 50 comprises a main setting menu, a security setting menu, an advanced setting menu, a boot menu and a save & exit menu. Under such circumstances, the user can utilize the security setting menu to input a predetermined password for initiating a disabling operation, so as to disable the initiated anti-theft operation, such that the authorized user can avoid being recognized as a theft.

In the embodiment of the invention, when the computer system 10 processes the BIOS setting menu (as shown in FIG. 5) of the BIOS, the anti-theft operation is correspondingly initiated to control the photographing module 104 for capturing the digital information. In detail, according to an available space of the BIOS ROM 108 or a flash memory module of the embedded controlling module 106, the two-dimensional/three-dimensional optical module of the photographing module 104 will adaptively process the photographing/recording operation to obtain the digital information considering different distances/angles away from the computer system 10. Accordingly, facial image information of the theft can be obtained without being notified/known by the theft.

Furthermore, after the anti-theft operation is initiated, the network module 110 of the computer system 10 can be correspondingly operated to establish the wireless/wired signal transmission operation between the computer system 10 and the remote server, so as to adaptively transmit the picture information and/or the video information to the remote server. The file format of the picture information and/or the video information can be transmitted to comply with the standards of TFTP or other peer-to-peer transmission protocols. Also, the user can adaptively select/modify sizes, numbers or formats of the transmitted digital information via the BIOS setting menu, which is not limiting the scope of the invention. Besides, the position module 112 of the invention can transmit the location coordinate information of the computer system 10 to the remote server after the anti-theft operation is initiated. Under such circumstances, the embodiment of the invention is not limiting operations for the user at the remote server, i.e. the remote server can adaptively process the recognition operation for the theft according to the received image information and/or the received video information, or the remote server can transmit the latest location coordinate of the computer system 10 to an owner or police officers to process another search operation, which is also in the scope of the invention.

Noticeably, the photographing module 104 in the embodiment of the invention can be cooperated with another fingerprint/voice recognition module or other recognition modules. In that, when the anti-theft process is initiated, the fingerprint/voice recognition module or the other recognition modules can correspondingly transmit the recognized fingerprint/voice information to the remote server, so as to assist the owner or the related police officers for precisely processing the search/recognition operation, which is also in the scope of the invention.

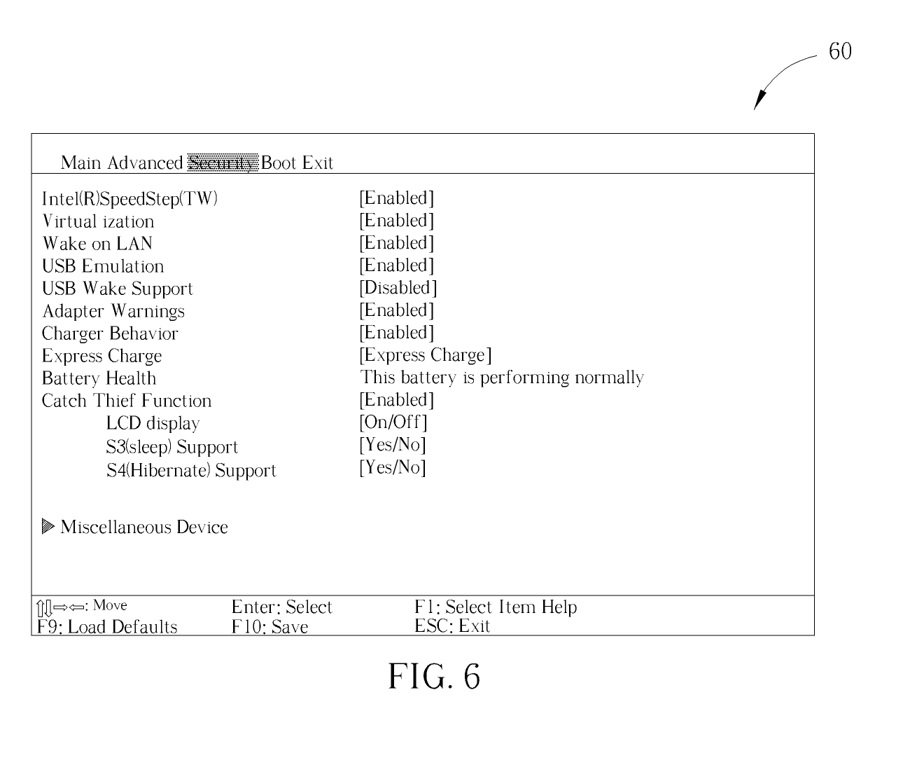

Those skilled in the art can predetermine other functional menus according to different requirements, such that the BIOS setting menu 50 can further comprise a display controlling menu or a mode controlling menu. Preferably, the display controlling menu is utilized to turn on/off a display monitor (not shown in the figure) of the computer system 10, such that the display monitor of the computer system 10 can be correspondingly turned on/off to show a warning picture/slogan for warning of the theft during initiating of the computer system 10 and processing of the anti-theft process. The mode controlling menu is utilized to determine whether the anti-theft is operated while the computer system is operated in a sleeping mode or a hibernation mode, so as to adaptively initiate the anti-theft operation for the computer system 10. Also, those skilled in the art can modify/adjust the BIOS setting menu to comprise only one of the plurality of setting menus, or dependencies of the plurality of setting menus can be adaptively changed/altered. For example, the security setting menu 60, as shown in FIG. 6, of the invention comprises the display controlling menu and the mode controlling menu as dependent menus thereof, which is also within the scope of the invention.

In addition, the authorized user can adaptively adjust mechanisms of the anti-theft process in the embodiment of the invention, such that different embodiments of the computer system 10 of the invention can be cooperated with the initiated photographing module 104. For example, the different embodiments of the computer system 10 can be realized as a mobile device or a laptop to process another mobile photographing/recording operation when the detection module 102 determines that the predetermined event is satisfied. Thus, these embodiments can be regarded as a camera or a video recorder, and accordingly, the display monitor can be utilized to display the captured pictures/video information, which is also in the scope of the invention. Besides, the embodiment of the invention does not limit numbers of the first detection unit 1020 and the second detection unit 1022. Also, disposition onto the computer system 10 of the first detection unit 1020 and the second detection unit 1022 can be arbitrary for convenience. In other words, those skilled in the art can adaptively adjust/modify/change the number and the disposition of the first detection unit 1020 and the second detection unit 1022, which is not limiting the scope of the invention.

In summary, the embodiments of the invention provide an anti-theft method for the computer system. While the computer system is operated in the turned off mode, the sleeping mode or the hibernation mode, the detection module can be utilized to determine whether the predetermined event is satisfied. While the predetermined event has satisfied, the embedded controlling module can be utilized to awake the computer system, so as to process the BIOS for initiating the anti-theft operation for controlling the photographing module, the position module and other recognition modules to transmit the digital information, the location coordinate information and the other recognition information, and accordingly, the remote server can adaptively process the recognition operation. In that, the embodiments of the invention can process different operations of the BIOS to efficiently process the anti-theft operation, so as to enlarge the application range as well as the protection mechanism of the computer system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An anti-theft method for a computer system comprising a detection module, a photographing module and a controlling module, the anti-theft method comprising:
when the computer system is off, the detection module determines whether a predetermined event occurs for generating a detection signal;
the controlling module initiates the computer system according to the detection signal, such that the computer system operates a basic input/output system (BIOS); and
when the computer system operates the BIOS, an anti-theft operation is initiated to control the photographing module for capturing a digital information.

2. The anti-theft method of claim 1, wherein the computer system further comprises a network module for transmitting the digital information to a remote server when the anti-theft operation is initiated, and the remote server is a trivial file transfer protocol (TFTP) server and the controlling module is an embedded controlling module.

3. The anti-theft method of claim 2, wherein the digital information is a video information or a picture information for the TFTP server to process a recognition operation of an object from the video information or the picture information.

4. The anti-theft method of claim 1, wherein the computer system further comprises a position module for generating at least a location coordinate of the computer system when the anti-theft operation is initiated.

5. The anti-theft method of claim 1, wherein the detection module further comprises:
a first detection unit for determining whether a first event of the predetermined event is satisfied, so as to correspondingly generate an initial detection signal; and
a second detection unit for receiving the initial detection signal and determining whether a second event of the predetermined event is satisfied, so as to correspondingly generate the detection signal.

6. The anti-theft method of claim 5, wherein the first event is a user entering into a predetermined space, and the first detection unit is a proximity sensor.

7. The anti-theft method of claim 5, wherein the second event is a luminance information, a moving information or a magnetic information, and the second detection unit is a light sensor, an accelerometer or a gyroscope, respectively.

8. The anti-theft method of claim 1, wherein a BIOS setting menu of the BIOS comprises a security setting menu, a display controlling menu or a mode controlling menu, wherein the security setting menu is utilized to initiate a disabling operation according to a predetermined password, so as to disable the initiated anti-theft operation; the display controlling menu is utilized to turn on/off a display monitor of the computer system; and the mode controlling menu is utilized to determine whether the anti-theft is operated while the computer system is operated in a sleeping mode or a hibernation mode.

9. A computer system comprising:
a detection module;
a photographing module;
a controlling module;
a central processing unit coupled to the detection module, the photographing module and the controlling module; and
a basic input/output system (BIOS) read-only memory (ROM) coupled to the central processing unit for storing a programming code, and the programming code is utilized to instruct the central processing unit for processing an anti-theft method comprising:
when the computer system is off, the detection module determines whether a predetermined event occurs for generating a detection signal;
the controlling module initiates the computer system according to the detection signal, such that the computer system operates a basic input/output system (BIOS); and
when the computer system operates the BIOS, an anti-theft operation is initiated to control the photographing module for capturing a digital information.

10. The computer system of claim 9, further comprising a network module for transmitting the digital information to a remote server when the anti-theft operation is initiated, wherein the remote server is a trivial file transfer protocol (TFTP) server and the controlling module is an embedded controlling module.

11. The computer system of claim 10, wherein the digital information is a video information or a picture information for the TFTP server to process a recognition operation of an object from the video information or the picture information.

12. The computer system of claim 9, further comprising a position module for generating at least a location coordinate of the computer system when the anti-theft operation is initiated.

13. The computer system of claim 9, wherein the detection module further comprises:
a first detection unit for determining whether a first event of the predetermined event is satisfied, so as to correspondingly generate an initial detection signal; and
a second detection unit for receiving the initial detection signal and determining whether a second event of the predetermined event is satisfied, so as to correspondingly generate the detection signal.

14. The computer system of claim 13, wherein the first event is a user entering into a predetermined space, and the first detection unit is a proximity sensor.

15. The computer system of claim 13, wherein the second event is a luminance information, and the second detection unit is a light sensor.

16. The computer system of claim 13, wherein the second event is a moving information, and the second detection unit is an accelerometer.

17. The computer system of claim 13, wherein the second event is a magnetic information, and the second detection unit is a gyroscope.

18. The computer system of claim 9, wherein a BIOS setting menu of the BIOS comprises a security setting menu, a display controlling menu or a mode controlling menu, wherein the security setting menu is utilized to initiate a disabling operation according to a predetermined password, so as to disable the initiated anti-theft operation; the display controlling menu is utilized to turn on/off a display monitor of the computer system; and the mode controlling menu is utilized to determine whether the anti-theft is operated while the computer system is operated in a sleeping mode or a hibernation mode.
